(19) United States
(12) Patent Application Publication
(10) Pub. No.: US 2020/0090879 A1
(43) Pub. Date: Mar. 19, 2020

(54) ELECTROCHEMICAL DEVICE, JOINED BODY, METHOD OF PRODUCING ELECTROCHEMICAL DEVICE, AND METHOD OF PRODUCING JOINED BODY

(71) Applicant: TAIYO YUDEN CO., LTD., Tokyo (JP)

(72) Inventors: Hiroto MORI, Takasaki-shi (JP); Katsunori YOKOSHIMA, Takasaki-shi (JP); Koji KANO, Takasaki-shi (JP)

(21) Appl. No.: 16/572,251

(22) Filed: Sep. 16, 2019

(30) Foreign Application Priority Data
Sep. 18, 2018 (JP) 2018-173723
Sep. 18, 2018 (JP) 2018-173724

(51) Int. Cl. H01G 11/06; H01M 2/26; H01M 10/04; H01M 10/0587; H01M 10/056; H01M 2/16; H01G 11/52; H01G 9/008; H01G 9/00; H01M 2/02; H01M 4/66; H01M 4/62

(52) U.S. Cl. CPC H01G 11/06; H01M 2/26; H01M 10/0409; H01M 10/0587; H01M 10/056; H01M 2/16; H01M 4/625; H01G 9/016; H01G 9/155; H01M 2/022; H01M 4/667; H01M 4/621; H01G 11/52

(57) ABSTRACT

An electrochemical device includes: an exterior can formed of metal containing a first metal type; an electricity storage device that includes a positive electrode, a negative electrode, and a separator, the positive electrode and the negative electrode being stacked via the separator and wound, the electricity storage device further including a lead plate that is electrically connected to one of the positive electrode and the negative electrode, contains a second metal type different from the first metal type, and is formed of metal different from that of the exterior can, the electricity storage device being housed in the exterior can; and a reinforcement plate formed of metal containing the first metal type, the exterior can and the reinforcement plate being welded with the lead plate being sandwiched therebetween, the first metal type and the second metal type coexisting at a welding portion thereof.

### CROSS REFERENCE TO RELATED APPLICATIONS

This application claims the benefit of Japanese Priority Patent Application JP 2018-173723 filed Sep. 18, 2018, the entire contents of which are incorporated herein by reference.

### BACKGROUND

The present disclosure relates to an electrochemical device including a conduction path joined by resistance welding, a joined body, a method of producing the electrochemical device, and a method of producing the joined body.

### BACKGROUND ART

In some electrochemical devices such as lithium ion capacitors, a positive electrode and a negative electrode are separated via a separator and wound, and they are housed in an exterior can. Each of the positive electrode and the negative electrode is configured by applying an active material to a current collector.

Note that one of the positive electrode and the negative electrode is electrically connected to the exterior can, and the exterior can is used as a conduction path for the positive electrode or the negative electrode in some cases. In the electrochemical device, further reduction in resistance is desired in order to achieve high output characteristics. Among the overall resistance, the ratio of resistance due to joining of the exterior can and an electrode is large.

In general, the joining of the exterior can and the electrode is performed by joining the current collector to the exterior can by resistance welding (see, for example, Japanese Patent Application Laid-open No. 2012-216653). In the resistance welding, an object to be welded is welded one by one to secure the strength.

### SUMMARY

Note that it is possible to reduce the connection resistance of the current collector and the exterior can by stacking a plurality of current collectors and directly joining the plurality of stacked current collectors to the exterior can at one point. However, in the resistance welding, an object to be welded is generally welded one by one, and there is a problem that it is difficult to secure the joining strength if stacking a plurality of current collectors and joining the plurality of current collectors to the exterior can by resistance welding.

In view of the above-mentioned circumstances, it is desired to provide an electrochemical device that includes a conduction path with low resistance and is capable of achieving high output characteristics, a joined body, a method of producing the electrochemical device, and a method of producing the joined body.

In accordance with an embodiment of the present disclosure, there is provided an electrochemical device, including: an exterior can; an electricity storage device; and a reinforcement plate.

The exterior can is formed of metal containing a first metal type.

The electricity storage device includes a positive electrode, a negative electrode, and a separator, the positive electrode and the negative electrode being stacked via the separator and wound, the electricity storage device further including a lead plate that is electrically connected to one of the positive electrode and the negative electrode, contains a second metal type different from the first metal type, and is formed of metal different from that of the exterior can, the electricity storage device being housed in the exterior can.

The reinforcement plate is formed of metal containing the first metal type.

The exterior can and the reinforcement plate are welded with the lead plate being sandwiched therebetween, the first metal type and the second metal type coexisting at a welding portion thereof.

With this configuration, the exterior can, the lead foil, and the reinforcement plate are welded while the lead foil is sandwiched between the exterior can and the reinforcement plate. At the welding portion, the first metal type contained in the exterior can and the reinforcement plate and the second metal type contained in the lead foil coexist, and it is possible to join the exterior can, the lead foil, and the reinforcement plate to each other with a high joining strength. Further, it is possible to reduce the resistance of the conduction path between the lead foil and the exterior can, and achieve high output characteristics.

The exterior can and the reinforcement plate may be welded with three or more lead plates being sandwiched therebetween.

The reinforcement plate may include a plate-like member having, as a main surface shape, a shape of an area including a central point of a circle in an area surrounded by a first straight line and a circumference of the circle, the first straight line being parallel to a central line that is a straight line passing through the central point of the circle, the circle having a diameter smaller than an inner diameter of the exterior can and larger than an outer diameter of the electricity storage device.

The reinforcement plate may include a first notch having a trapezoidal shape, the trapezoidal shape having a part of a second straight line as an upper base, a part of the first line as a lower base, and two straight lines as oblique sides, the second straight line being located between the central line and the first straight line in the circle and parallel to the central line, the two straight lines passing through the central point of the circle.

The reinforcement plate may include a second notch having a shape of an area not including the central point of the circle in an area surrounded by a third straight line and a circumference of the circle in the circle, the third straight line being located on an opposite side of the first straight line with respect to the central line and parallel to the central line.

In the first notch, the upper base may have a width not less than a width of the lead foil and not more than a width obtained by adding 2 mm to the width of the lead foil.

The exterior can and the reinforcement plate may be formed of the same metal.

The first metal type may iron, and the second metal type may be copper.

Each of the exterior can and the reinforcement plate may further contain nickel.

In accordance with an embodiment of the present disclosure, there is provided a joined body, including: a first member; a plurality of foils; and a second member.

The first member is formed of metal containing a first metal type.

The plurality of foils is each formed of metal that contains a second metal type and is different from that of the first member, the second metal type being different from the first metal type.

The second member is formed of metal containing the first metal type.

The first member and the second member are welded with the plurality of foils being sandwiched therebetween, the first metal type and the second metal type coexisting at a welding portion thereof.

In accordance with an embodiment of the present disclosure, there is provided a method of producing an electrochemical device, including:

preparing an exterior can formed of metal containing a first metal type, an electricity storage device that includes a positive electrode, a negative electrode, and a separator, the positive electrode and the negative electrode being stacked via the separator and wound, the electricity storage device further including a lead plate that is electrically connected to one of the positive electrode and the negative electrode, contains a second metal type different from the first metal type, and is formed of metal different from that of the exterior can, the electricity storage device being housed in the exterior can, and a reinforcement plate formed of metal containing the first metal type;

sandwiching the lead plate between the exterior can and the reinforcement plate;

bringing a first welding electrode into contact with the exterior can;

bringing a second welding electrode into contact with the reinforcement plate; and

applying a voltage between the first welding electrode and the second welding electrode to join the exterior can and the reinforcement plate by resistance welding with the lead plate being sandwiched therebetween.

In accordance with an embodiment of the present disclosure, there is provided a method of producing a joined body, including: preparing a first member formed of metal containing a first metal type, a plurality of foils each formed of metal that contains a second metal type and is different from that of the first member, the second metal type being different from the first metal type, and a second member formed of metal containing the first metal type;

sandwiching the plurality of lead foils between the first member and the second member;

bringing a first welding electrode into contact with the first member;

bringing a second welding electrode into contact with the second member; and

applying a voltage between the first welding electrode and the second welding electrode to join the first member and the second member by resistance welding with the plurality of lead foils being sandwiched therebetween.

As described above, in accordance with the present disclosure, it is possible to provide an electrochemical device that includes a conduction path with low resistance and is capable of achieving high output characteristics, a joined body, a method of producing the electrochemical device, and a method of producing the joined body.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a perspective view showing an electrochemical device according to an embodiment of the present disclosure;

FIG. 2 is a perspective view showing a partial configuration of the electrochemical device;

FIG. 3 is a perspective view showing an electricity storage device of the electrochemical device;

FIG. 4 is a cross-sectional view of the electricity storage device;

FIG. 5 is a plan view showing a negative electrode of the electricity storage device;

FIG. 6 is a plan view showing a positive electrode of the electricity storage device;

FIG. 7 is a schematic diagram showing a negative electrode lead foil and a positive electrode lead foil of the electricity storage device;

FIG. 8 is a schematic diagram showing a mode of electrical connection between the electricity storage device and a container;

FIG. 9 is a schematic diagram showing a mode of resistance welding of the negative electrode lead foil and the exterior can of the electricity storage device by an existing method;

FIG. 10 is a schematic diagram showing a mode of resistance welding of the negative electrode lead foil and the exterior can of the electricity storage device by a method according to an embodiment of the present disclosure;

FIG. 11 is a schematic diagram showing a mode of joining of the electricity storage device and the exterior can by using a reinforcement plate;

FIG. 12 is a schematic diagram showing welding portions of the negative electrode lead foil of the electricity storage device with the exterior can and the reinforcement plate;

FIG. 13 is a plan view showing a reinforcement plate of an electrochemical device according to an embodiment of the present disclosure;

FIG. 14 is a schematic diagram showing the shape of the reinforcement plate;

FIG. 15 is a schematic diagram showing the size of the reinforcement plate;

FIG. 16 is a schematic diagram showing the reinforcement plate and the negative electrode lead foil;

FIG. 17 is a plan view showing a reinforcement plate of the electrochemical device according to an embodiment of the present disclosure;

FIG. 18 is a schematic diagram showing the shape of the reinforcement plate;

FIG. 19 is a schematic diagram showing the size of the reinforcement plate;

FIG. 20 is a schematic diagram showing the reinforcement plate and the negative electrode lead foil; and

FIG. 21 is a schematic diagram showing the reinforcement plate and the negative electrode lead foil.

### DETAILED DESCRIPTION OF EMBODIMENTS

An electrochemical device according to an embodiment of the present disclosure will be described.

[Configuration of Electrochemical Device]

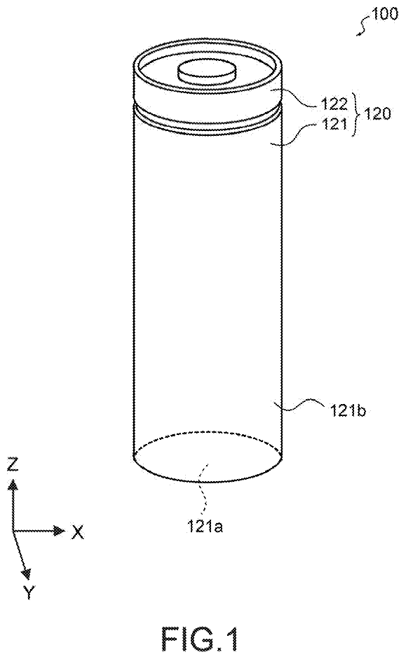

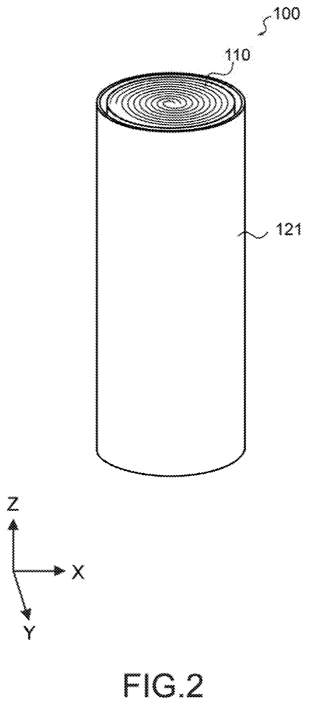

FIG. 1 is a perspective view showing an electrochemical device 100 according to an embodiment of the present disclosure, and FIG. 2 is a perspective view showing a partial configuration of the electrochemical device 100. Note that in the following drawings, X-, Y-, and Z-directions are three directions orthogonal to each other.

The electrochemical device 100 only needs to be a device capable of charging and discharging, and may be any of various electrochemical devices such as a lithium ion capacitor, an electric double layer capacitor, and a lithium ion secondary battery.

As shown in FIG. 1 and FIG. 2, the electrochemical device 100 includes an electricity storage device 110 and a container 120. The electrochemical device 100 has a cylindrical shape, and can have a diameter (X-Y direction) of 18 mm and a length (Z-direction) of 65 mm, for example.

As shown in FIG. 1, the container 120 includes an exterior can 121 and a sealing body 122.

The exterior can 121 is formed of metal, and includes a can bottom portion 121a and a side wall portion 121b. The can bottom portion 121a has a disk shape. The side wall portion 121b has a cylindrical shape that is continuous with the periphery of the can bottom portion 121a. The side wall portion 121b is covered by an insulating film.

The sealing body 122 is formed of metal and joined to the side wall portion 121b to seal the internal space of the exterior can 121.

As shown in FIG. 2, the electricity storage device 110 and an electrolyte (not shown) are housed in the exterior can 121 and sealed by the sealing body 122, thereby forming the electrochemical device 100.

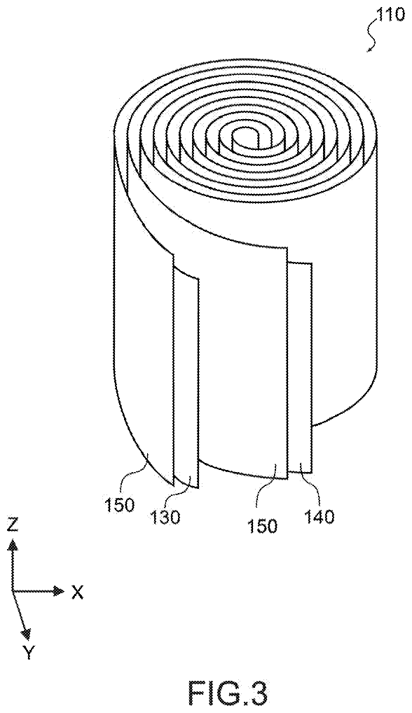

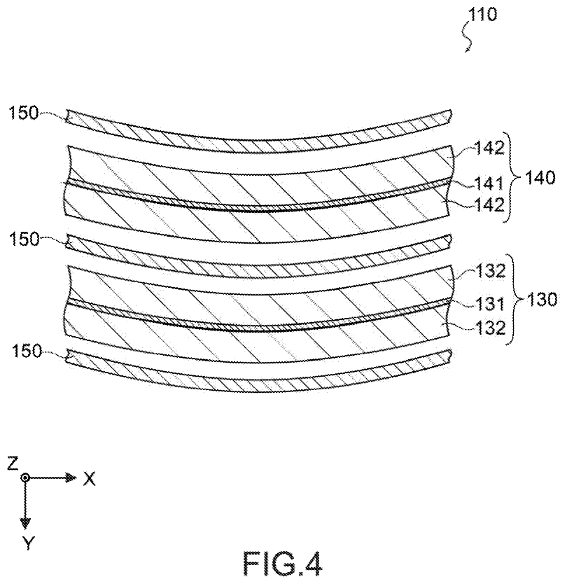

FIG. 3 is a perspective view showing the electricity storage device 110. FIG. 4 is an enlarged cross-sectional view of the electricity storage device 110. As shown in the figures, the electricity storage device 110 includes a negative electrode 130, a positive electrode 140, and a separator 150. A stacked body obtained by stacking the negative electrode 130, the positive electrode 140, and the separator 150 is wound to form the electricity storage device 110.

As shown in FIG. 4, the negative electrode 130 includes a negative electrode current collector 131 and a negative electrode active material layer 132. The negative electrode current collector 131 is formed of a conductive material, and can be a metal foil such as a copper foil. It is favorable that the negative electrode current collector 131 includes a metal foil having a surface that is chemically or mechanically roughened or a metal foil in which a through hole is formed.

The negative electrode active material layer 132 is formed on both of the front surface and the back surface of the negative electrode current collector 131. The material of the negative electrode active material layer 132 may be a mixture of a negative electrode active material and a binder resin, and may further contain a conductive aid. The negative electrode active material can be, for example, a carbon-based material such as hard carbon, graphite, and soft carbon.

The binder resin is a synthetic resin that joins a negative electrode active material, and can be, for example, carboxymethylcellulose, styrene butadiene rubber, polyethylene, polypropylene, aromatic polyamide, fluorinated rubber, polyvinylidene fluoride, isoprene rubber, butadiene rubber, or ethylene propylene rubber.

The conductive aid is particles formed of a conductive material, and improves the conductivity with the negative electrode active material. Examples of the conductive aid include a carbon material such as graphite and carbon black. These materials may be used alone, or two or more of them may be used in combination. Note that the conductive aid may be a metal material, a conductive polymer, or the like as long as the material has conductivity.

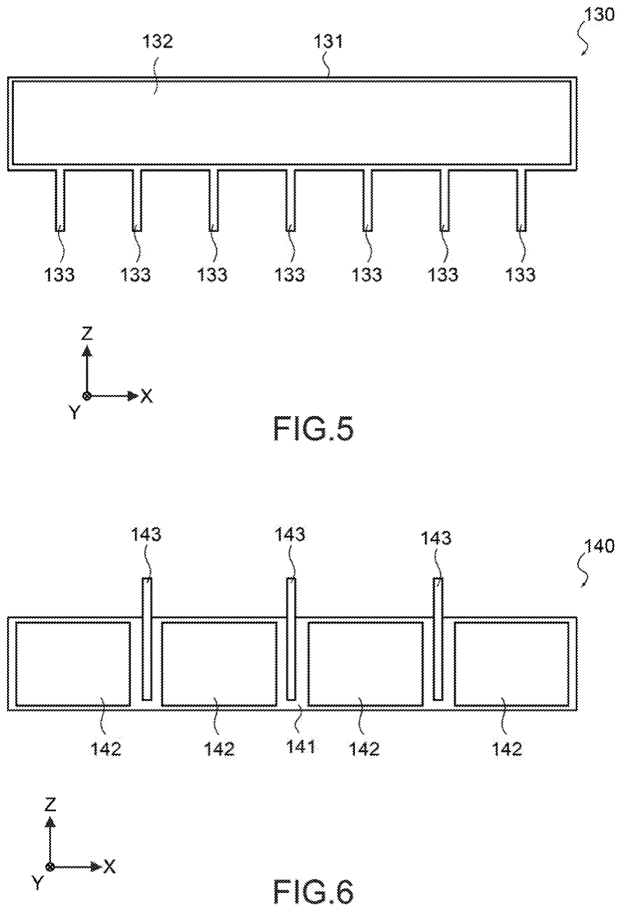

FIG. 5 is a plan view showing the negative electrode 130 before being wound. As shown in FIG. 5, the negative electrode active material layer 132 is stacked on most of the surface of the negative electrode current collector 131. Further, similarly, the negative electrode active material layer 132 (not shown) is stacked also on the back surface of the negative electrode current collector 131.

Further, the negative electrode 130 includes negative electrode lead foils 133. A part of the negative electrode current collector 131 projects, thereby forming each of the negative electrode lead foils 133. As will be described below, the negative electrode lead foils 133 are connected to the exterior can 121, and electrically connect the exterior can 121 and the negative electrode 130.

Note that each of the negative electrode lead foils 133 does not necessarily need to be a projecting part of the negative electrode current collector 131, and may be a foil-like member electrically connected to the negative electrode current collector 131, which is different from the negative electrode current collector 131. The number of the negative electrode lead foils 133 is not limited to seven shown in FIG. 5, and may be an arbitrary number of one or more.

As shown in FIG. 4, the positive electrode 140 includes a positive electrode current collector 141 and a positive electrode active material layer 142. The positive electrode current collector 141 is formed of a conductive material, and can be a metal foil such as an aluminum foil. It is favorable that the positive electrode current collector 141 includes a metal foil having a surface that is chemically or mechanically roughened or a metal foil in which a through hole is formed.

The positive electrode active material layer 142 is formed on both of the front surface and the back surface of the positive electrode current collector 141. The material of the positive electrode active material layer 142 can be a mixture of a positive electrode active material and a binder resin, and may further contain a conductive aid. Examples of the positive electrode active material include activated carbon, PAS (Polyacenic Semiconductor: polyacenic organic semiconductor), or the like.

The binder resin is a synthetic resin that joins a positive electrode active material, and can be, for example, carboxymethylcellulose, styrene butadiene rubber, polyethylene, polypropylene, aromatic polyamide, fluorinated rubber, polyvinylidene fluoride, isoprene rubber, butadiene rubber, or ethylene propylene rubber.

The conductive aid is particles formed of a conductive material, and improves the conductivity with the positive electrode active material. Examples of the conductive aid include a carbon material such as graphite and carbon black. These materials may be used alone, or two or more of them may be used in combination. Note that the conductive aid may be a metal material, a conductive polymer, or the like as long as the material has conductivity.

FIG. 6 is a plan view showing the positive electrode 140 before being wound. As shown in FIG. 6, the positive electrode active material layer 142 is stacked on most of the surface of the positive electrode current collector 141. Further, similarly, the positive electrode active material layer 142 (not shown) is stacked also on the back surface of the positive electrode current collector 141.

Further, the positive electrode 140 includes a positive electrode lead foil 143. The positive electrode lead foil 143 is connected to an area, to which the positive electrode active material layer 142 is not applied, on the positive electrode current collector 141, and is covered by an insulating tape (not shown). As will be described below, the positive electrode lead foil 143 is connected to the sealing body 122, and electrically connects the sealing body 122 and the positive electrode 140.

Note that a part of the positive electrode current collector 141 may protrude to form the positive electrode lead foil 143. The number of the positive electrode lead foils 143 is not limited to three shown in FIG. 5, and only needs to be one or more.

The separator 150 is disposed between the negative electrode 130 and the positive electrode 140, insulates the negative electrode 130 and the positive electrode 140, and causes ions contained in the electrolyte to be transmitted therethrough. The separator 150 can be a porous sheet formed of woven fabric, non-woven fabric, glass fiber, cellulose fiber, plastic fiber, or the like.

The electrochemical device 100 is configured as described above. The electrolyte to be housed in the container 120 together with the electricity storage device 110 can be arbitrarily selected in accordance with the type of the electrochemical device 100.

[Regarding Material]

Each of the exterior can 121 and the negative electrode lead foil 133 is formed of metal. Note that the exterior can 121 is formed of metal containing a first metal type. The first metal type is favorably iron. The exterior can 121 can be formed of iron. Further, the exterior can 121 may be formed of an alloy containing iron. Further, the exterior can 121 may be formed of stainless steel.

Further, the exterior can 121 favorably contains nickel in addition to iron. The exterior can 121 may be formed of an alloy of iron and nickel. Further, the exterior can 121 may be obtained by performing nickel plating on a base formed of iron.

Further, the negative electrode lead foil 133 contains a second metal type, and is formed of metal different from the exterior can 121. The second metal type is a metal type different from the first metal type. The second metal type is favorably copper. The negative electrode lead foil 133 can be formed of copper. Further, the negative electrode lead foil 133 may be formed of an alloy containing copper.

The material of the exterior can 121 favorably has a melting point higher than that of the material of the negative electrode lead foil 133.

[Regarding Electrical Connection Between Electricity Storage Device and Exterior Can]

In the electrochemical device 100, the negative electrode 130 and the positive electrode 140 are respectively electrically connected to the exterior can 121 and the sealing body 122, and charging and discharging of the electricity storage device 110 is performed via the exterior can 121 and the sealing body 122.

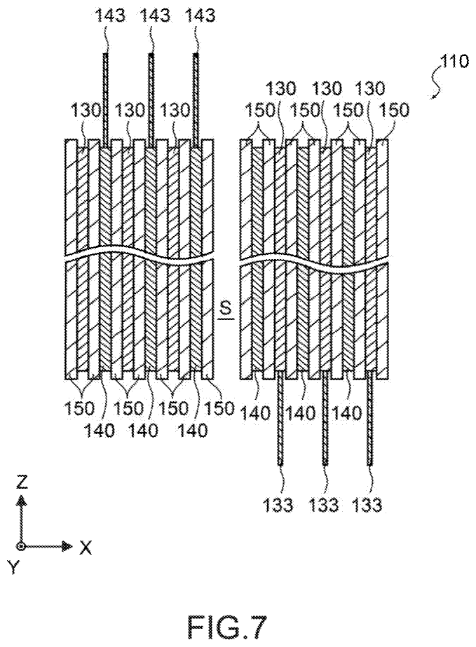

FIG. 7 is a schematic cross-sectional view of the electricity storage device 110. As shown in FIG. 7, the negative electrode 130 and the positive electrode 140 are separated via the separator 150 and wound. As shown in FIG. 7, a hole at the winding center will be referred to as “central hole S”. The negative electrode lead foil 133 projects from the negative electrode 130 to one side (downward in FIG. 7) of the electricity storage device 110, and the positive electrode lead foil 143 projects from the positive electrode 140 to the opposite side (upward in FIG. 7).

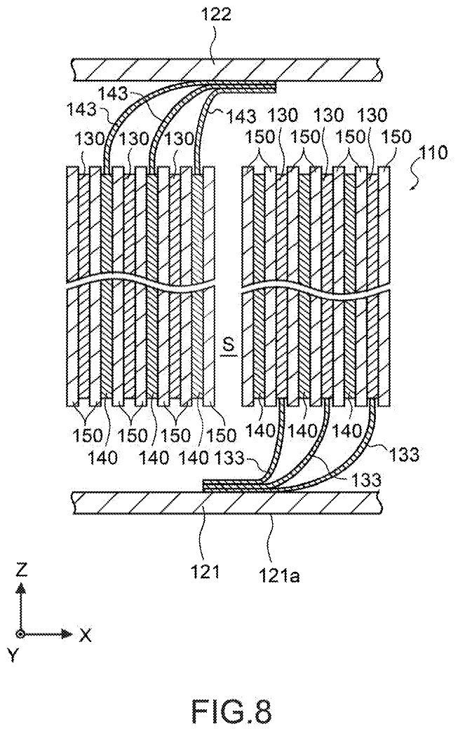

FIG. 8 is a schematic diagram showing the electrical connection between the electricity storage device 110 and the container 120. As shown in FIG. 8, the negative electrode lead foil 133 is joined to the can bottom portion 121a of the exterior can 121, and the positive electrode lead foil 143 is joined to the sealing body 122. As a result, the can bottom portion 121a of the exterior can 121 functions as a negative electrode terminal, and the sealing body 122 functions as a positive electrode terminal.

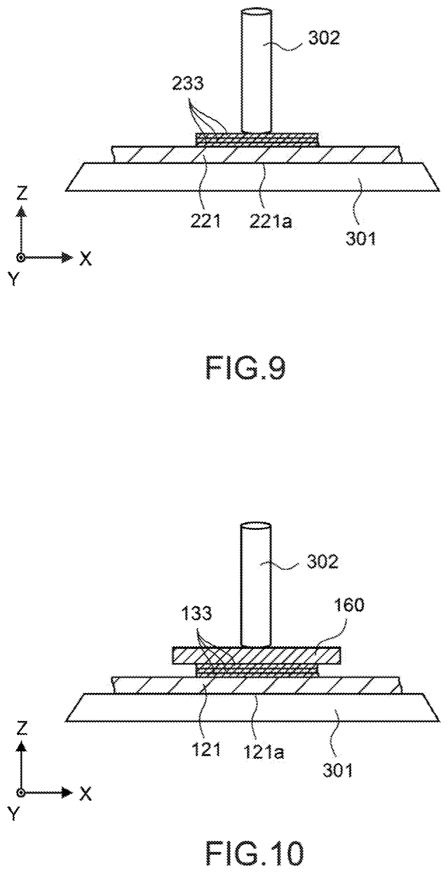

Note that the joining of the negative electrode lead foil 133 and the exterior can 121 is performed by resistance welding. FIG. 9 is a schematic diagram showing resistance welding of the negative electrode lead foil and the exterior can by a general method. As shown in FIG. 9, in the case of joining a plurality of negative electrode lead foils 233 and an exterior can 221 by resistance welding, the negative electrode lead foils 233 is placed on a can bottom portion 221a of the exterior can 221 and the exterior can 221 is brought into contact with a lower welding electrode 301.

Further, an upper welding electrode 302 is brought into contact with the negative electrode lead foils 233, and a voltage is applied between the upper welding electrode 302 and the lower welding electrode 301.

As a result, a current flows between the upper welding electrode 302 and the lower welding electrode 301 via the negative electrode lead foils 233 and the exterior can 221, and the negative electrode lead foils 233 and the exterior can 221 are welded (resistance welding) due to heat generated by resistance.

However, in the case where the negative electrode lead foil 233 includes a plurality of negative electrode lead foils 233, the negative electrode lead foil 233 in the upper layer (on the side of the upper welding electrode 302) is heated, but the negative electrode lead foil 233 in the lower layer (on the side of the exterior can 221) is not sufficiently heated. As a result, the joining strength of the negative electrode lead foils 233 and the exterior can 221 is insufficient. In particular, the exterior can 221 and the negative electrode lead foils 233 are formed of different types of metal, the joining strength tends to be insufficient.

For this reason, in the electrochemical device 100, resistance welding of the negative electrode lead foil 133 and the exterior can 121 is performed as follows. FIG. 10 is a schematic diagram showing resistance welding of the negative electrode lead foil 133 and the exterior can 121 by the method according to the embodiment of the present disclosure.

As shown in FIG. 10, the electrochemical device 100 according to the embodiment of the present disclosure, the negative electrode lead foils 133 are placed on the exterior can 121, and the lower welding electrode 301 is brought into contact with the exterior can 121. Further, a reinforcement plate 160 is placed on the negative electrode lead foils 133, and thus, the negative electrode lead foil 133 is sandwiched between the exterior can 121 and the reinforcement plate 160. The upper welding electrode 302 is brought into contact with the reinforcement plate 160. Note that the upper welding electrode 302 can be brought into contact with the negative electrode lead foil 133 via the central hole S (see FIG. 7).

The reinforcement plate 160 includes a plate-like member formed of metal, and contains the above-mentioned first metal type. The reinforcement plate 160 is favorably formed of the same material as the exterior can 121. Further, the thickness of each of the reinforcement plate 160 and the exterior can 121 is favorably larger than the total thickness of the negative electrode lead foils 133 to be welded.

In the case where a voltage is applied between the upper welding electrode 302 and the lower welding electrode 301 in this state, a current flows between the upper welding electrode 302 and the lower welding electrode 301 via the reinforcement plate 160, the negative electrode lead foils 133, and the exterior can 121. At this time, the reinforcement plate 160, the negative electrode lead foils 133, and the exterior can 121 are welded (resistance welding) due to heat generated by resistance.

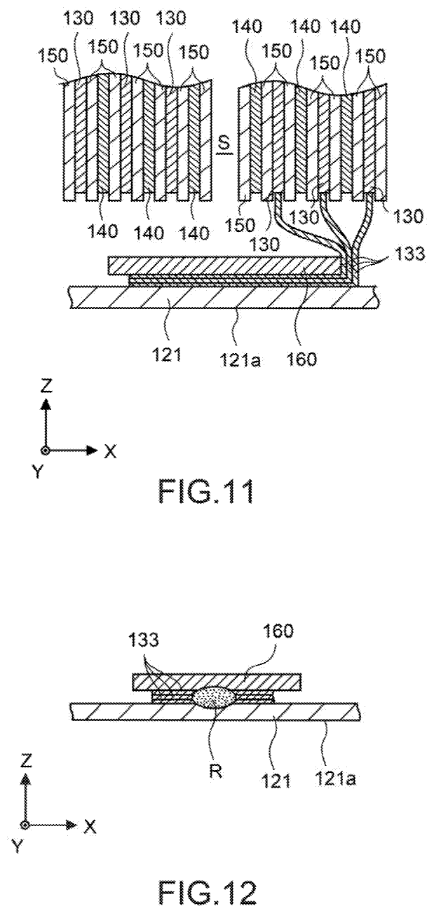

FIG. 11 is a schematic diagram showing the electrochemical device 100, and shows the state in which resistance welding is performed using the reinforcement plate 160. FIG. 12 is a schematic enlarged view showing a resistance welding portion of the electrochemical device 100. As shown in FIG. 12, a material coexisting area R is formed at the welding portion of the reinforcement plate 160, the negative electrode lead foils 133, and the exterior can 121.

The material coexisting area R is an area in which the materials of the reinforcement plate 160, the negative electrode lead foil 133, and the exterior can 12 are partially melted by welding and coexist. As described above, the reinforcement plate 160 and the exterior can 121 each contain the first metal type, and the negative electrode lead foils 133 contain the second metal type. Therefore, in the material coexisting area R, the first metal type and the second metal type coexist.

By performing resistance welding while sandwiching the plurality of negative electrode lead foils 133 between the reinforcement plate 160 and the exterior can 121, the plurality of negative electrode lead foil 133 is uniformly heated to form the material coexisting area R in which the first metal type and the second metal type coexist.

In particular, in the case where the first metal type is iron and the second metal type is copper, iron and copper mutually diffuse and the material coexisting area R is favorably formed. Further, in the case where the reinforcement plate 160 and the exterior can 121 each contain nickel, since copper and nickel have good compatibility, the material coexisting area R in which metal types coexist in the order of iron-nickel-copper from the central portion of the material coexisting area R is formed.

As a result, it is possible to join the reinforcement plate 160, the negative electrode lead foil 133, and the exterior can 121 to each other with a high joining strength. Further, since the contact area between the reinforcement plate 160, the negative electrode lead foil 133, and the exterior can 121 increases, it is possible to reduce the resistance of the conduction path between the negative electrode lead foil 133 and the exterior can 121, and realize the reduction of heat generation and alleviation of device deterioration even in the case where a large current is input/output.

The number of the negative electrode lead foils 133 that can be joined by the method according to the embodiment of the present disclosure is not particularly limited but is favorably three or more, and welding can be performed with a sufficient strength by up to approximately 12 negative electrode lead foils 133.

[Regarding Shape of Reinforcement Plate]

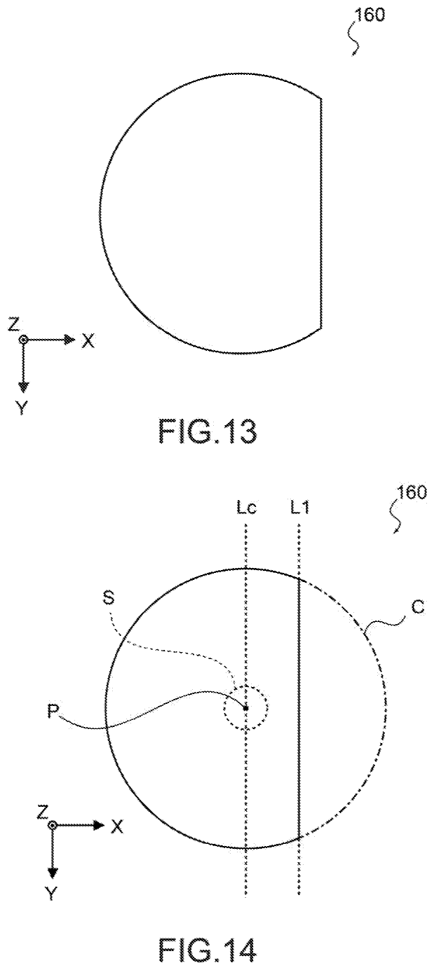

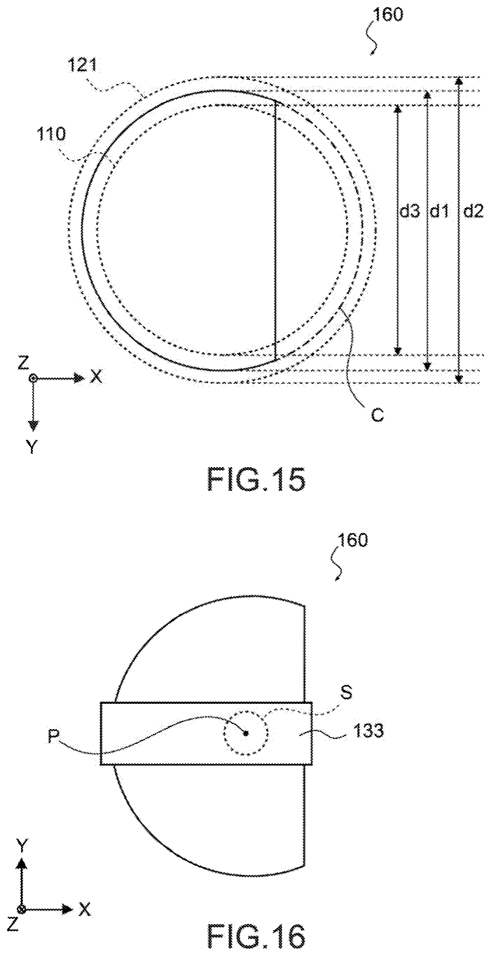

FIG. 13 is a plan view showing the shape of the reinforcement plate 160. FIG. 14 is a schematic diagram showing the shape of the reinforcement plate 160. FIG. 15 is a schematic diagram showing the size of the reinforcement plate 160. As shown in the figures, the reinforcement plate 160 has a D-shape obtained by removing a part of a circle as viewed in the direction perpendicular to the main surface. Hereinafter, this circle will be referred to as “circle C”.

As shown in FIG. 14, the center of the circle C will be referred to as “central point P”. The central point P faces the central hole S (see FIG. 7), and the upper welding electrode 302 is in contact with the central point P.

As shown in FIG. 14, a straight line passing through the central point P will be referred to as “central line Lc”, and a straight line parallel to the central line Lc will be referred to as “the straight line L1”. The reinforcement plate 160 includes a plate-like member having, as a main surface shape, the shape of an area including the central point P in an area surrounded by the straight line L1 and the circumference of the circle C. The distance between the central line Lc and the straight line L1 can be, for example, 3 mm.

Further, as shown in FIG. 15, assuming that the diameter of the circle C is a diameter d1, the diameter d1 is smaller than an inner diameter d2 of the exterior can 121 and larger than an outer diameter d3 of the electricity storage device 110. For example, the diameter d1 can be, for example, 16.5 mm.

FIG. 16 shows the state in which the negative electrode lead foil 133 is caused to abut on the reinforcement plate 160. By forming the reinforcement plate 160 in a D-shape, a clearance for causing the negative electrode lead foil 133 to pass between the reinforcement plate 160 and the can bottom portion 121a from the electricity storage device 110 is secured, and there is no load on the electricity storage device 110 due to the negative electrode lead foil 133 being pulled.

Further, even if the reinforcement plate 160 is slightly displaced before performing resistance welding, the reinforcement plate 160 can move only in the direction of rotation about the central point P. For this reason, as shown in FIG. 16, the central point P constantly faces the central hole S and the upper welding electrode 302 reliably abuts on the reinforcement plate 160. Further, by disposing the reinforcement plate 160 between the electricity storage device 110 and the can bottom portion 121a, the electricity storage device 110 is prevented from rattling.

As a result, it is possible to secure the strength of the welding portion. Further, the contact area of the negative electrode lead foil 133 and the reinforcement plate 160 increases, the resistance can be reduced, and it is possible to reduce the heat generation and alleviate the device deterioration even in the case where a large current is input/output.

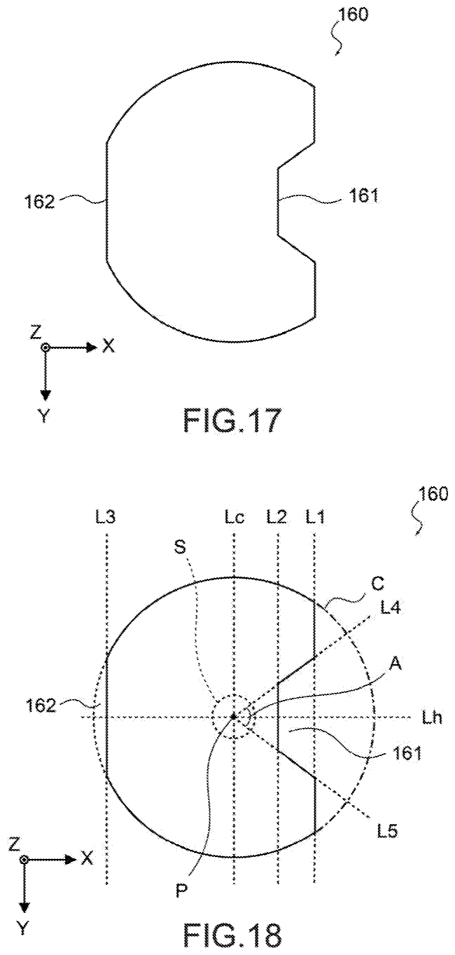

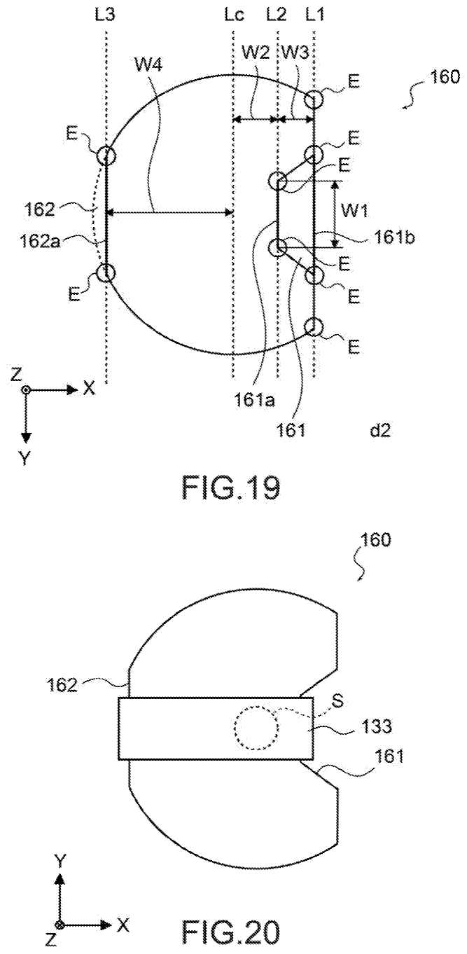

Further, a notch may be provided in the reinforcement plate 160. FIG. 17 is a plan view showing the reinforcement plate 160 including a notch. FIG. 18 is a schematic diagram showing the shape of the reinforcement plate 160. FIG. 19 is a schematic diagram showing the size of each portion of the reinforcement plate 160.

As shown in FIG. 17, the reinforcement plate 160 has a shape obtained by adding a notch 161 and a notch 162 to the above-mentioned D-shape.

As shown in FIG. 18, a straight line that is located between the central line Lc and the straight line L1 and is parallel to the central line Lc will be referred to as “straight line L2”. Further, a straight line that is parallel to the central line Lc and located on the opposite side of the straight line L1 with respect to the central line Lc will be referred to as “straight line L3”. Further, two straight lines symmetrical to a straight line Lh that passes through the central point P and is perpendicular to the central line Lc will be referred to as “straight line L4” and “straight line L5”.

The notch 161 is a trapezoidal notch having a part of the straight line L2 as an upper base, a part of the straight line L1 as a lower base, and a part of the straight line L4 and the straight line L5 as an oblique side. An angle A formed by the straight line L4 and the straight line L5 is favorably 45°.

Further, the notch 162 is a notch having the shape of an area not including the central point P in an area surrounded by the straight line L3 and the circumference of the circle C.

As shown in FIG. 19, assuming that the upper base of the notch 161 having a trapezoidal shape is an upper base 161a and a lower base thereof is a the lower base 161b, a width W1 of the upper base 161a is favorably more than the width of the negative electrode lead foil 133 and not more than the width obtained by adding 2 mm to the width of the negative electrode lead foil 133.

Further, a width W2 between the central line Lc and the upper base 161a can be, for example, 3 mm, and a width W3 between the upper base 161a and the lower base 161b can be, for example, 2 mm.

Further, assuming that the side on the straight line L3 in the notch 162 is a side 162a, a width W4 between the central line Lc and the side 162a can be, for example, 7 mm.

Note that it is favorable that respective angles E of the reinforcement plate 160 shown in FIG. 19 are formed to achieve R0.5 so as not to damage the electricity storage device 110.

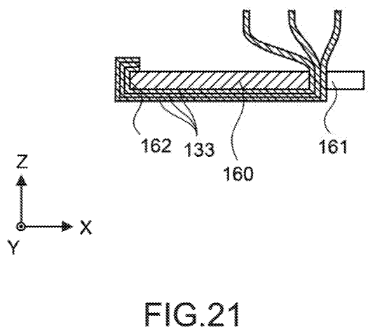

FIG. 20 and FIG. 21 are each a schematic diagram showing the state in which the negative electrode lead foil 133 is caused to abut on the reinforcement plate 160. As shown in the figures, by providing the notch 161 having a trapezoidal shape, when causing the negative electrode lead foils 133 to pass from the notch 161 to the can bottom portion 121a, it is possible to gather the negative electrode lead foils 133 at the central portion of the reinforcement plate 160 by the oblique side of the notch 161. Further, by bending the end portion of each of the negative electrode lead foils 133 through the notch 162, it is possible to fix the position of the negative electrode lead foil 133 with respect to the reinforcement plate 160.

As a result, the negative electrode lead foils 133 are aligned on the opposite side of the central hole S, and resistance welding is reliably performed by the upper welding electrode 302.

Further, depending on the production process, the negative electrode lead foil 133 is wound while the reinforcement plate 160 stands against the electricity storage device 110, and resistance welding is performed while the negative electrode lead foil 133 is turned over. At this time, if the negative electrode lead foil 133 is pulled, there is a risk that the negative electrode lead foil 133 is damaged.

Meanwhile, by providing the notch 161, the negative electrode lead foil 133 is not pulled when turning the reinforcement plate 160 over, it is possible to prevent the negative electrode lead foil 133 from being damaged.

### Modified Example

Although the configuration in which the negative electrode lead foils 133 are joined to the exterior can 121 by resistance welding has been described above, instead of the negative electrode lead foils 133, the positive electrode lead foils 143 may be joined to the exterior can 121 by the above-mentioned method. In this case, by sandwiching the positive electrode lead foils 143 between the exterior can 121 and the reinforcement plate 160 to perform resistance welding, it is possible to join the plurality of positive electrode lead foils 143 with a high joining strength.

Further, the method according to the embodiment of the present disclosure is applicable also to resistance welding of things other than the electrochemical device. Specifically, by sandwiching a plurality of metal foils between a first member and a second member, causing a welding electrode to abut on each of the first member and the second member, and applying a current between the welding electrodes, it is possible to prepare a joined body in which the plurality of metal foils is joined between the first member and the second member.

By forming each of the first member and the second member of metal containing the first metal type and forming the metal foil of metal containing the second metal type, a material coexisting area in which the first metal type and the second metal type coexist is formed, and it is possible to join the plurality of metal foils with a high joining strength.

It should be understood by those skilled in the art that various modifications, combinations, sub-combinations and alterations may occur depending on design requirements and other factors insofar as they are within the scope of the appended claims or the equivalents thereof.

What is claimed is:

1. An electrochemical device, comprising:
an exterior can formed of metal containing a first metal type;
an electricity storage device that includes a positive electrode, a negative electrode, and a separator, the positive electrode and the negative electrode being stacked via the separator and wound, the electricity storage device further including a lead plate that is electrically connected to one of the positive electrode and the negative electrode, contains a second metal type different from the first metal type, and is formed of metal different from that of the exterior can, the electricity storage device being housed in the exterior can; and
a reinforcement plate formed of metal containing the first metal type,
the exterior can and the reinforcement plate being welded with the lead plate being sandwiched therebetween, the first metal type and the second metal type coexisting at a welding portion thereof.

2. The electrochemical device according to claim 1, wherein
the exterior can and the reinforcement plate are welded with three or more lead plates being sandwiched therebetween.

3. The electrochemical device according to claim 1, wherein
the reinforcement plate includes a plate-like member having, as a main surface shape, a shape of an area including a central point of a circle in an area surrounded by a first straight line and a circumference of the circle, the first straight line being parallel to a central line that is a straight line passing through the central point of the circle, the circle having a diameter smaller than an inner diameter of the exterior can and larger than an outer diameter of the electricity storage device.

4. The electrochemical device according to claim 3, wherein
the reinforcement plate includes a first notch having a trapezoidal shape, the trapezoidal shape having a part of a second straight line as an upper base, a part of the first line as a lower base, and two straight lines as oblique sides, the second straight line being located between the central line and the first straight line in the circle and parallel to the central line, the two straight lines passing through the central point of the circle.

5. The electrochemical device according to claim 3, wherein
the reinforcement plate includes a second notch having a shape of an area not including the central point of the circle in an area surrounded by a third straight line and a circumference of the circle in the circle, the third straight line being located on an opposite side of the first straight line with respect to the central line and parallel to the central line.

6. The electrochemical device according to claim 4, wherein
in the first notch, the upper base has a width not less than a width of the lead foil and not more than a width obtained by adding 2 mm to the width of the lead foil.

7. The electrochemical device according to claim 1, wherein
the exterior can and the reinforcement plate are formed of the same metal.

8. The electrochemical device according to claim 1, wherein
the first metal type is iron, and
the second metal type is copper.

9. The electrochemical device according to claim 8, wherein
each of the exterior can and the reinforcement plate further contains nickel.

10. A joined body, comprising:
a first member formed of metal containing a first metal type;
a plurality of foils each formed of metal that contains a second metal type and is different from that of the first member, the second metal type being different from the first metal type; and
a second member formed of metal containing the first metal type,
the first member and the second member being welded with the plurality of foils being sandwiched therebetween, the first metal type and the second metal type coexisting at a welding portion thereof.

11. A method of producing an electrochemical device, comprising:
preparing
an exterior can formed of metal containing a first metal type,
an electricity storage device that includes a positive electrode, a negative electrode, and a separator, the positive electrode and the negative electrode being stacked via the separator and wound, the electricity storage device further including a lead plate that is electrically connected to one of the positive electrode and the negative electrode, contains a second metal type different from the first metal type, and is formed of metal different from that of the exterior can, the electricity storage device being housed in the exterior can, and
a reinforcement plate formed of metal containing the first metal type;
sandwiching the lead plate between the exterior can and the reinforcement plate;
bringing a first welding electrode into contact with the exterior can;
bringing a second welding electrode into contact with the reinforcement plate; and
applying a voltage between the first welding electrode and the second welding electrode to join the exterior can and the reinforcement plate by resistance welding with the lead plate being sandwiched therebetween.

12. A method of producing a joined body, comprising:
preparing
a first member formed of metal containing a first metal type,
a plurality of foils each formed of metal that contains a second metal type and is different from that of the first member, the second metal type being different from the first metal type, and
a second member formed of metal containing the first metal type;
sandwiching the plurality of lead foils between the first member and the second member;
bringing a first welding electrode into contact with the first member;
bringing a second welding electrode into contact with the second member; and
applying a voltage between the first welding electrode and the second welding electrode to join the first member and the second member by resistance welding with the plurality of lead foils being sandwiched therebetween.
